(19) United States
(12) Patent Application Publication
(10) Pub. No.: US 2008/0054781 A1
(43) Pub. Date: Mar. 6, 2008

(54) Glass Case for Cathode Ray Tubes

(76) Inventors: Stefano Necci, Anagni (IT); Carlo Tulli, Roma (IT); Paolo Ginesti, Gavignano (IT); Renzo Incagli, Colleferro (Roma) (IT)

Correspondence Address: THOMSON LICENSING LLC, Two Independence Way, Suite 200, PRINCETON, NJ, 08540, US

(21) Appl. No.: 11/664,654

(22) PCT Filed: Oct. 6, 2005
(86) PCT No.: PCT/FR05/50817

§ 371 Date: Apr. 4, 2007

(30) Foreign Application Priority Data
Oct. 12, 2004 (IT) MI2004A001929

(51) Int. Cl. H01J 29/87

(52) U.S. Cl. 313/477 R

(57) ABSTRACT

Cathode ray tube for which the front face is flat and/or for which the deflection angle is greater than 110°. The tube comprises a front panel supporting a luminescent screen surrounded by a flange perpendicular to the panel, the said panel being defined by: a thickness t at the corner of the screen,
a distance t1 between the corner of the screen and the free edge of the flange,
a rear part in the form of a funnel, whose tapered free edge is arranged at the distance t2 from the reference line of the tube.

The tube is characterized by values of t, t1, t2 chosen in such a manner that the ratio A=(t1+/t)/t2 is between the range of values [0.0061Θm−7.8 10⁻⁶(Θm)²±0.05]. for which Θm is expressed in degrees. Hence, the quantity of glass reduced while providing the mechanical strength necessary for resisting the application of a vacuum to the tube.

The present invention relates to a cathode ray tube and more particularly to the front face of a tube optimised in thickness in a manner to reduce the transmission gradient of light emitted by a luminescent material screen through this front face as well as the weight of material required to guarantee the mechanical strength when a vacuum is applied to the said tube.

Conventional cathode ray tubes comprise a colour selection mask situated inside the glass front face of the tube, front face on which networks of red, green and blue luminophores are laid to form a screen, the said front face being practically perpendicular to the longitudinal axis Z of the tube.

The mask is constituted by a metal sheet pierced in the middle part with many holes or slots. An electron gun arranged inside the rear part of the tube generates three electronic beams in the direction of the front face. An electromagnetic deflection device, generally located outside the tube and close to the electron gun has the function of deviating the electronic beams so as to sweep them over the surface of the panel on which the luminophore networks are arranged. Under the influence of three electronic beams each corresponding to a determined primary colour, the luminophore networks reproduce colour pictures on the screen, the mask enabling each determined beam to illuminate only the luminophore of the corresponding colour.

The colour selection mask must be arranged and maintained in a specific position within the tube during the operation of the tube. The mask support functions are realised owing to a generally very rigid rectangular metal frame on which the mask is conventionally welded. The frame/mask assembly is mounted in the front face using suspension means most frequently welded on the frame and co-operating with lugs inserted into the glass constituting the front face of the tube.

Tubes with the front face increasingly flat correspond to the current trend, with an evolution towards completely flat front faces

The front faces of such tubes are generally constituted by an external surface defined by very large radii, and by an internal surface of smaller radii such that the thickness of this face is smaller at its centre than at the edges, this is in order to guarantee the mechanical strength against implosion when a vacuum is applied within the tube.

In the case where to improve the contrast of the picture formed on the screen of the tube, the front face uses a dark glass of lower transparency for example 80%, the differences in glass thickness between the centre and the edges of the screen are such that the luminosity of a picture will not be rendered uniformly between the said centre and the said edges.

Moreover, the thicknesses at different points of the front face must be optimised in a manner to guarantee sufficient mechanical strength against implosion while using the minimum of material so as to reduce the weight of the tube and its production cost.

One of the purposes of the invention is to describe a method of designing a front face of a cathode ray tube that tends to optimise the transmission of light over most of its surface while reducing the quantity of glass to produce the said front face and guaranteeing its mechanical strength against implosion.

For this, a cathode ray tube according to the invention is constituted by a glass envelope comprising:
a front part in the form of a panel supporting on its internal face a luminophore screen noticeably rectangular in shape, of diagonal equal to d, the said panel being constituted by a front face surrounded by a peripheral flange extending in a direction noticeably perpendicular to the screen, the said panel moreover being defined by:
   an external surface for which the radius of curvature measured according to the diagonal of the screen is R,
   a thickness T at the centre of the screen,
   a thickness t at the corner of the screen,
   a distance t1 between the corner of the screen and the free edge of the flange of the front part,
a rear part in the form of a funnel, whose tapered free edge is sealed at the front part of the tube, this free edge being arranged at the distance t2 from the reference line of the tube,
a cylindrical collar extending at the rear of the tapered part, longitudinally according to the main axis Z of the tube passing through the centre of the front face,
an electron gun inserted into the collar of the tube whose emitted rays are intended to be deviated according to an angle Θm to sweep over the surface of the luminophore screen,
   the said tube being characterized in that the ratio A=(t1+t)/t2 is chosen in the range of values [0.0061Θm−7.8 10⁻⁶(Θm)²±0.05]. for which Θm is expressed in degrees.

The invention and its different advantages will be better understood from the following description and drawings, wherein:

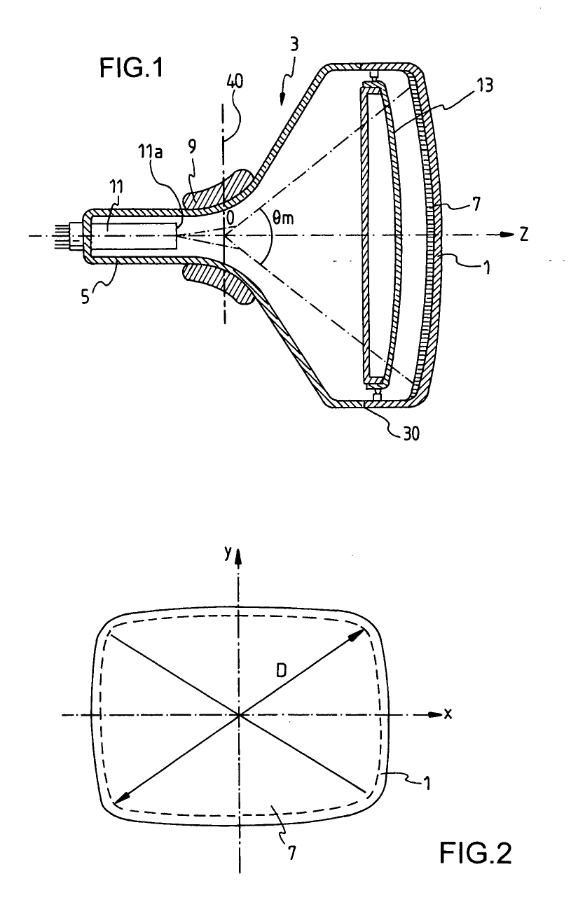

FIG. 1 is a cross-section view of a cathode ray tube according to the invention, the cross-section being made in a plane containing the longitudinal axis Z of the tube and a diagonal of the screen

FIG. 2 is a front view of the front panel of the tube

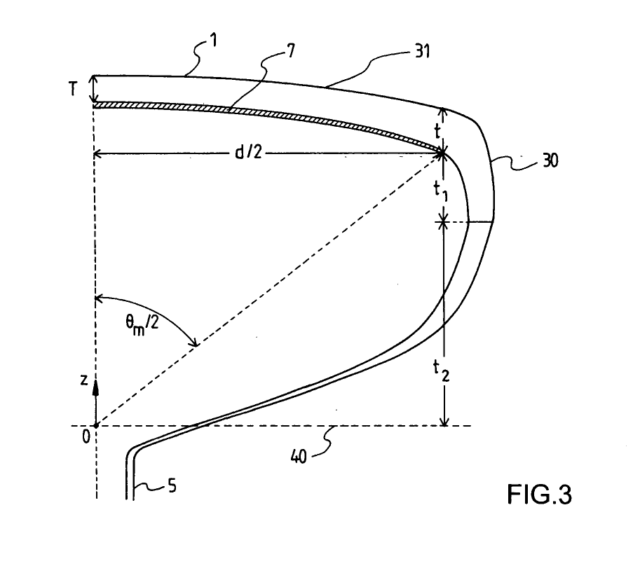

FIG. 3 specifies the different characteristics implemented to produce the invention.

As shown in FIG. 1, a cathode ray tube comprises a central, longitudinal axis Z passing through the centre of the cylindrical collar 5 and through the middle of the panel 1. The panel supports a luminophore screen 7 realising a coloured picture when it is swept by the electron beams from the gun 11. The electron beams are deviated by a magnetic deflection device 9 arranged at the back of the tapered part 3 in the form of a funnel, sealed at one end to the cylindrical collar and at the other end to the peripheral flange 30 of the panel 1, the said flange extending in a direction noticeably parallel to the longitudinal axis Z.

To sweep over the entire surface of the screen 7, the electron beams must be deviated to sweep the entire useful surface of the luminescent screen 7. Once the electrons have left the zone of influence of the magnetic deviation device, their trajectories become noticeably rectilinear and appear to emanate, by prolongation of the rectilinear part of their trajectories, from the point O called deflection centre. The angle formed by the straight lines connecting the point O to the two opposite extremities of a diagonal of the screen 7 is the deflection angle Θm.

FIG. 2 shows a front view of the front face of the panel 1, a noticeably rectangular face, with the large sides arranged according to directions parallel to the horizontal axis X, and the small sides arranged according to directions parallel to the vertical axis Y.

The plane containing the point, and perpendicular to the longitudinal axis Z, determines, in the cut plane of FIG. 1, what those skilled in the art generally call the reference line 40 of the tube. This line is the reference serving to position the different components of the tube (deviator 9, gun 11, etc.) in relation to each other.

To produce a tube whose external surface 31 of the front panel 1 is noticeably flat, large glass thicknesses are generally used to maintain the mechanical strength of the tube against implosion: the tubes according to prior art show a very large thickness of glass on the peripheral edges of the screen, a thickness that decreases toward the centre of the said screen. Moreover, the use of the tubes in surroundings that can be highly luminous requires a screen showing a high contrast to be obtained. This contrast is generally obtained using a front panel of dark glass, that is having a light transmission coefficient lower than 80%. However, the use of a dark glass panel of variable thickness between the centre and the edge causes a high light transmission gradient through the said panel and this non-uniformity of transmission thus becomes visible and inconvenient for the viewer.

The current trend of decreasing the depth of the tubes by increasing the angle of deflection makes these phenomena still more visible as it occurs through an increase in the glass thickness to resist the mechanical stress acting on the panel.

The modelling of the tube with a view to determining the mechanical stress using finite elements analysis has enabled, within the framework of the invention, to show that the optimisation of the quantity of glass to be used, aiming to reduce the quantity of glass while maintaining sufficient mechanical strength against implosion, was dependent on the deflection angle Θm of the said tube, the length of this tube according to the longitudinal direction Z, its thickness t at the corner of the screen, the length of the flange of the panel, such that A being equal to (t1+t)/t2 (where t1 is the distance between the corner of the screen and the free edge of the flange of the front part of the tube and t2 is the distance between the tapered free edge of the rear part 3 in the form of a funnel and the reference line of the tube), the value of A chosen belongs to the range of values:
[0.0061Θm−7.8 10⁻⁶(Θm)²±0.05]. (1)
for which Θm is expressed in degrees.

The optimisation of the quantity of glass to use is crucial from an economic point of view (reduced material cost and reduced manufacturing costs) for the tubes for which the external surface of the front panel is noticeably flat (having for example a radius of curvature according to the horizontal axis greater than 20 m), as these tubes, to resist the application of a vacuum, use large thicknesses of glass. Likewise, the tubes with a large deflection angle, for example greater than 110°, use large thicknesses of glass for the same reasons.

Moreover, the study seeking to reduce the transmission gradient of the light and the minimum thickness of glass of the front panel so as to obtain the mechanical strength necessary for applying a vacuum to the envelope, results in choosing, for a given screen dimension (d), a radius of curvature (R) of the external surface of the panel, the thicknesses of glass
t−T≦R+14.61−\sqrt{R²−d²/4} (2)

The last relationship is particularly advantageous when the glass of the front panel is dark and in particular when the light transmission coefficient of the said panel is chosen so as to be less than 80%.

The invention has been implemented for the design of front panels of a screen diagonal equal to 680 mm, of 4/3 format, for which the transmission coefficient of the glass is between 60% and 80% respectively for the panel of the tube called MK having a Θm value equal to 106° and for the panel of the tube called SLIM for which Θm=120°.

Starting from a thickness at the centre T enabling a sufficient mechanical strength against implosion to be obtained, according to the methods known by those skilled in the art for designing a cathode ray tube envelope, the front panel was optimised using the relationships (1) (2), both to reduce the quantity of glass to use and to standardise the transmission coefficient of the glass on the screen surface.

The relationships (1) and (2) are used to determine t, t1 and t2 enabling these results to be obtained:

| | | | | | | min A | max A |
|---|---|---|---|---|---|---|---|
| | | t | t1 | t2 | | according | according |
| | Θm | (mm) | (mm) | (mm) | A | to (2) | to (2) |
| A68MK | 106° | 23.1 | 76.3 | 179.1 | 0.55 | 0.51 | 0.61 |
| A68SLIM | 120° | 24.3 | 59.3 | 135.4 | 0.62 | 0.57 | 0.67 |

| | | | | | | (t − T)(mm) max |
|---|---|---|---|---|---|---|
| | | R | T | (t − T) | t | according |
| | Θm | (mm) | (mm) | (mm) | (mm) | to (1) |
| A68MK | 106° | 100000 | 12.5 | 10.6 | 23.1 | 15.19 |
| A68SLIM | 120° | 30000 | 13.0 | 11.3 | 24.3 | 16.54 |

The relationships (1) and (2) can be implemented independently from each other according to the results required. Although the invention was realized for tubes with noticeably flat front panels, and/or reduced depth tubes (namely, with a deflection angle greater than 110°), it can be implemented with the same advantages for the design of curved front panel tubes and for tubes with a deflection angle in the order of 90°.

1/ Cathode ray tube constituted by a glass envelope comprising:
a front part in the form of a panel supporting on its internal face a luminophore screen noticeably rectangular in shape, of diagonal equal to d, the said panel being constituted by a front face surrounded by a peripheral flange extending in a direction noticeably perpendicular to the screen, the said panel moreover being defined by:
an external surface for which the radius of curvature measured according to the diagonal of the screen is R,
a thickness T at the centre of the screen,
a thickness t at the corner of the screen,
a distance t1 between the corner of the screen and the free edge of the flange of the front part,
a rear part in the form of a funnel, whose tapered free edge is sealed at the front part of the tube, this free edge being arranged at the distance t2 from the reference line of the tube,
a cylindrical collar extending at the rear of the tapered part, longitudinally according to the main axis Z of the tube passing through the centre of the front face,
an electron gun inserted into the collar of the tube whose emitted rays are intended to be deviated to sweep over the surface of the luminophore screen,
the said tube wherein the ratio A=(t1+t)/t2 is chosen in the range of values [0.0061(Θm)−7.8 10⁻⁶(Θm)²±0.05] for which (Θm) is the value of the deflection angle of the said tube expressed in degrees, this value of (Θm) being greater than or equal to 106.

2/ Cathode ray tube according to claim 1, wherein the different dimensions being expressed in mm, the following inequality is met:
t−T≦R+14.61−\sqrt{R²−d²/4}

3/ Cathode ray tube according to claim 1, wherein the radius of curvature of the external surface is greater than 20 metres.

4/ Cathode ray tube according to claim 1, wherein the light transmission coefficient of the panel is less than 80%.

5. (canceled)
